(19) United States
(12) Patent Application Publication
(10) Pub. No.: US 2010/0250494 A1
(43) Pub. Date: Sep. 30, 2010

(54) PERIPHERAL DEVICE AND PORTABLE ELECTRONIC DEVICE

(76) Inventor: Wei-Chen Lee, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/726,355

(22) Filed: Mar. 18, 2010

(30) Foreign Application Priority Data
Mar. 27, 2009 (TW) 098110159

(51) Int. Cl. G06F 12/16; G06F 12/14; G06F 13/20; G06F 17/30

(52) U.S. Cl. 707/640; 713/189; 710/305; 707/E17.005; 707/E17.009

(57) ABSTRACT

A peripheral device and a portable electronic device are disclosed. The peripheral device is capable of being connected with a data processing system, and the peripheral device includes a transmission module, a control module, and a storage module. The transmission module is capable of being connected with the data processing system. The control module is connected with the transmission module. The control module automatically executing a backup program and an encryption program to copy a target file in the data processing system to be a backup file by the transmission module and to encrypt the backup file when the transmission module is connected with the data processing system. The storage module is connected with the control module for receiving the backup file from the control module and storing the backup file.

### CROSS-REFERENCE TO RELATED APPLICATIONS

This Non-provisional application claims priority under 35 U.S.C. §119(a) on Patent Application No(s). 098110159 filed in Taiwan, Republic of China on Mar. 27, 2009, the entire contents of which are hereby incorporated by reference.

### BACKGROUND OF THE INVENTION

1. Field of the Invention

This invention relates to a peripheral device and, more particularly, to a peripheral device capable of being connected with a data processing system, thus to automatically back up data in the data processing system and to encrypt the backup data.

2. Description of the Related Art

With improvement of information technology, a plurality of data processing systems, such as a computer, a personal digital assistant, a mobile phone and so on, are developed and applied in daily life.

Usually, the data processing systems have memory modules such as a memory or storage modules such as a hard disk for storing data by the users. In addition, the data processing systems are usually installed with operation systems such as a Windows operation system for a computer, a Symbian operation system for a mobile phone and so on. The operation system provides an operation environment to facilitate operating the data processing system to process the stored data by the users.

When some accidental events happen, the operation system or data stored in the data processing system may be lost or damaged.

Therefore, it is necessary to provide a convenient backup solution to regularly back up important data in the data processing system.

### BRIEF SUMMARY OF THE INVENTION

One objective of this invention is to provide a peripheral device for connecting a data processing system. Particularly, the peripheral device in the invention can automatically backs up data in the data processing system.

According one embodiment of the invention, a peripheral device includes a transmission module, a control module, and a storage module. The transmission module is capable of being connected with a data processing system. The control module is connected with the transmission module. When the transmission module is connected with the data processing system, the control module automatically executes a backup program and an encryption program to copy a target file in the data processing system to generate a backup file by the transmission module and to encrypt the backup file. The storage module is connected with the control module for receiving the backup file from the control module and storing the backup file.

In one embodiment, the control module may encrypt the backup file. When a user plugs the peripheral device in the invention into the data processing system and needs to read the backup file stored in the peripheral device, the control module generates a password request image and transmits the password request image to the data processing system by the transmission module, such that the data processing system displays the password request image and requests the user to enter a correct password to read the backup file.

In one embodiment, the backup program may be included in software and be stored in the storage module. When the transmission module is connected with the data processing system, the control module executes the backup program, or the software is transmitted to the data processing system by the control module and is automatically executed by the data processing system.

In addition, in one embodiment, the backup program may be firmware and be recorded onto the control module. When the transmission module is connected with the data processing system, the control module automatically executes the backup program.

Another objective of the invention is to provide a portable electronic device for connecting a data processing system. Particularly, the portable electronic device in the invention can automatically back up data in the data processing system.

According one embodiment of the invention, a portable electronic device includes a transmission module, a control module, and a storage module. The transmission module is capable of being connected with a data processing system. The control module is connected with the transmission module. When the transmission module is connected with the data processing system, the control module automatically executes a backup program to copy a target file in the data processing system to generate a backup file by the transmission module. The storage module is connected with the control module for receiving the backup file from the control module and storing the backup file.

To sum up, when the peripheral device or the portable electronic device in the embodiments of the invention is connected with the data processing system, it automatically back up the target file in the data processing system. The invention provides a more convenient backup mode for the users to regularly back up important data, thus to prevent the data from failing to be recovered after being damaged by external factors.

These and other features, aspects, and advantages of the present invention will become better understood with regard to the following description, appended claims, and accompanying drawings.

### BRIEF DESCRIPTION OF THE DRAWINGS

FIG. 1 is a functional block diagram showing a mouse connected with a notebook computer according to one embodiment of the invention;

FIG. 2 is a schematic diagram showing a mouse connected with a notebook computer according to one embodiment of the invention;

FIG. 3 is a functional block diagram showing a multimedia player connected with a notebook computer according to one embodiment of the invention; and

FIG. 4 is a schematic diagram showing a multimedia player connected with a notebook computer according to one embodiment of the invention.

### DETAILED DESCRIPTION OF THE INVENTION

This invention provides a peripheral device for connecting a data processing system and automatically backing up a target file in the data processing system. A plurality of embodiments according to the invention are disclosed hereinbelow.

The peripheral device in embodiments may be an input device such as a mouse or a keyboard, a storage device such as a universal serial bus (USB), a multimedia player device such as a MP3 player or a MP4 player, or other peripheral devices. The data processing system in embodiments may be a desktop computer, a notebook computer, a tablet computer, a personal digital assistant (PDA), a mobile communication device and so on. However, the invention is not limited thereto.

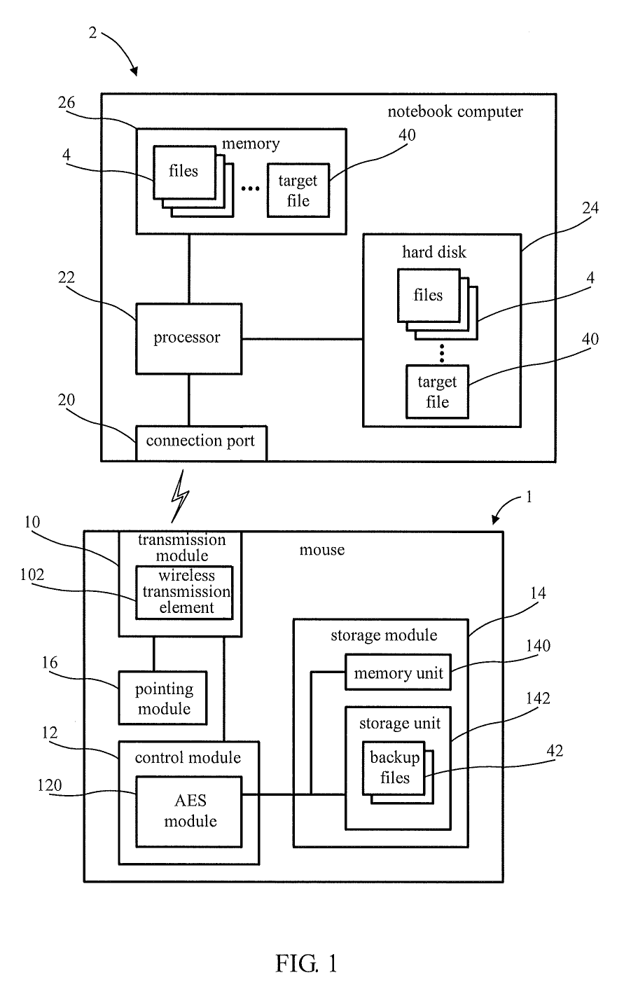

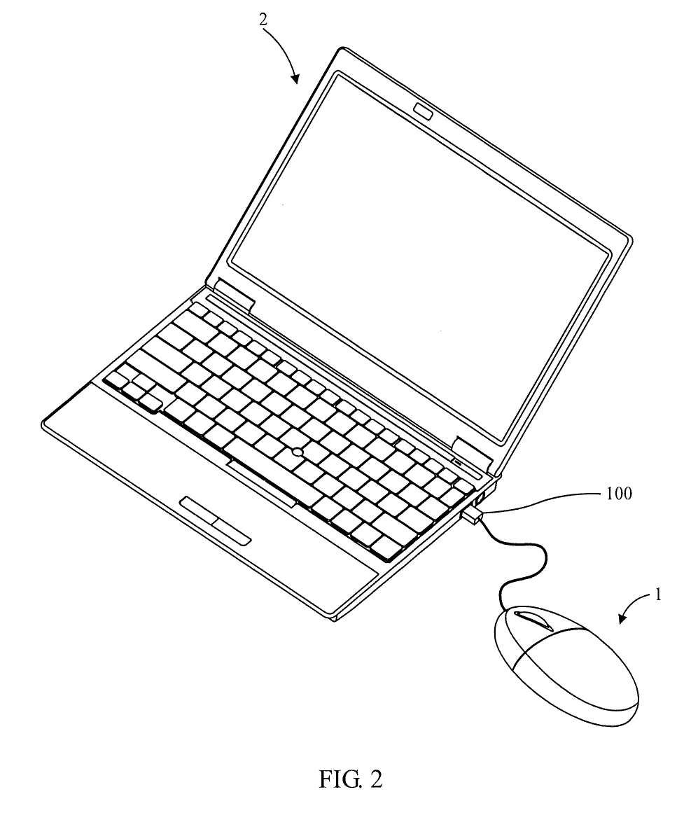

A mouse as the peripheral device is taken for example in one embodiment of the invention, and a notebook computer as the data processing system is taken for example in one embodiment of the invention hereinbelow. Please refer to FIG. 1 and FIG. 2 together. FIG. 1 is a functional block diagram showing a mouse 1 connected with a notebook computer 2. FIG. 2 is a schematic diagram showing the mouse 1 connected with the notebook computer 2. The mouse 1 in FIG. 1 is connected with the notebook computer 2 in a wireless mode, while the mouse 1 in FIG. 2 is connected with the notebook computer 2 in a wired mode.

In FIG. 1, in the embodiment, the mouse 1 includes a transmission module 10, a control module 12, and a storage module 14. Further, the storage module 14 includes a memory unit 140 and a storage unit 142.

The notebook computer 2 includes a connection port 20, a processor 22, a hard disk 24, and a memory 26. Further, the hard disk 24 and the memory 26 store a plurality of files 4, respectively. Usually, the files 4 stored in the memory 26 are system files for operating system, and the files 4 stored in the hard disk 24 are data files of a user. In addition, the user may operate the notebook computer 2 to set some of the files 4 to be target files 40. In an actual application, the user may set all of the files 4 to be the target files 40.

Further, the transmission module 10 of the mouse 1 may include a USB hub or a bridge, and the transmission module 10 is connected with the notebook computer 2 by a USB plug 100, as shown in FIG. 2. Otherwise, the transmission module 10 can also include a wireless transmission element 102, such as a Bluetooth transmission element, for wirelessly connecting the connection port 20 of the notebook computer 2, as shown in FIG. 1. Certainly, in an actual application, the transmission module 10 may also be a transmission module in other types cooperating with a plug and a connection port in other types.

The control module 12 may be a chip connected with the transmission module 10. Particularly, when the transmission module 10 is connected with the notebook computer 2, the control module 12 automatically executes a backup program for copying the target files 40 to generate backup files 42 by the transmission module 10.

The backup program may be executed in different methods to achieve a backup function. For example, in one embodiment, the memory unit 140 or the storage unit 142 of the storage module 14 stores backup software including the back up program. When the transmission module 10 is connected with the notebook computer 2, the control module 12 executes the backup program. In another embodiment, when the transmission module 10 is connected with the notebook computer 2, the control module 12 transmits the backup software including the backup program to the notebook computer 2, and the notebook computer 2 executes the backup program.

In addition, in an actual application, the backup program is recorded onto the control module 12 in the mode of a program code. When the transmission module 10 is connected with the notebook computer 2, the control module 12 automatically executes the backup program.

In another embodiment, the backup software including the backup program is stored in the notebook computer 2. When the transmission module 10 is connected with the notebook computer 2, the control module 12 transmits a driving signal by the transmission module 10 to drive the notebook computer 2 to execute the backup program.

In the embodiment, the encryption program in embodiments may be included in an advanced encryption standard (AES) module 120. the control module 12 includes the advanced encryption standard (AES) module 120 for encrypting the backup files 42 and storing the encrypted backup files 42.

When the user plugs the mouse 1 into the notebook computer 2 or other data processing systems, and the user is to read the backup files 42 stored in the mouse 1, the control module 12 generates a password request image and transmits the password request image to the notebook computer 2 by the transmission module 10, such that the notebook computer 2 displays the password request image and requests the user to enter a correct password to read the backup files 42. Thus, security of the backup files 42 is ensured.

The password may be set by the user via the notebook computer 2 and be stored in the memory unit 140 of the storage module 14. Certainly, in an actual application, the mouse 1 may also have a fingerprint identification module or other security modules for identifying whether the user of the mouse 1 is authorized. Otherwise, the mouse 1 may also cooperate with a security mechanism of the notebook computer 2. The notebook computer 2 may be used to identify the user, and then whether the user can read the backup files 42.

Further, the storage module 14 is connected with the control module 12 for receiving the backup files 42 from the control module 12. In the embodiment, the backup files 42 are stored in the storage unit 142.

The storage module 14 or the storage unit 142 may be pluggably disposed in the mouse 1. For example, the storage module 14 or the storage unit 142 may be a memory card using a flash memory, such as a CF card, an MS card, an SD card, an XD card, an MMC card and so on, a mini hard disk, or other removable storage media, and the storage module 14 or the storage unit 142 is plugged into the mouse 1 via a connection port.

Since the capacity of the storage module 14 or the storage unit 142 is limited, all of the backup files 42 may not be stored therein. Therefore, the user may set priority of the target files 40. For example, system files may be given the highest priority, or some files with high importance may be given the highest priority, etc. Thus, when the capacity of the storage module 14 or the storage unit 142 is not enough, the control module 12 or the notebook computer 2 can first copy the target files 40 with high priority. Certainly, in an actual application, the control module 12 or the notebook computer 2 may also determine which of the target files 40 are copied first according to some predetermined mechanisms.

In addition, since the peripheral device in the embodiment is the mouse 1, the mouse 1 further includes a pointing module 16 for sensing displacement of the mouse 1 and controlling a cursor displayed on a screen of the notebook computer 2 to move correspondingly.

The invention further provides a portable electronic device for connecting a notebook computer for automatically backing up a target file in the notebook computer. The portable electronic device in the invention can be a mobile phone, a PDA, a multimedia player and so on. However, the invention is not limited thereto.

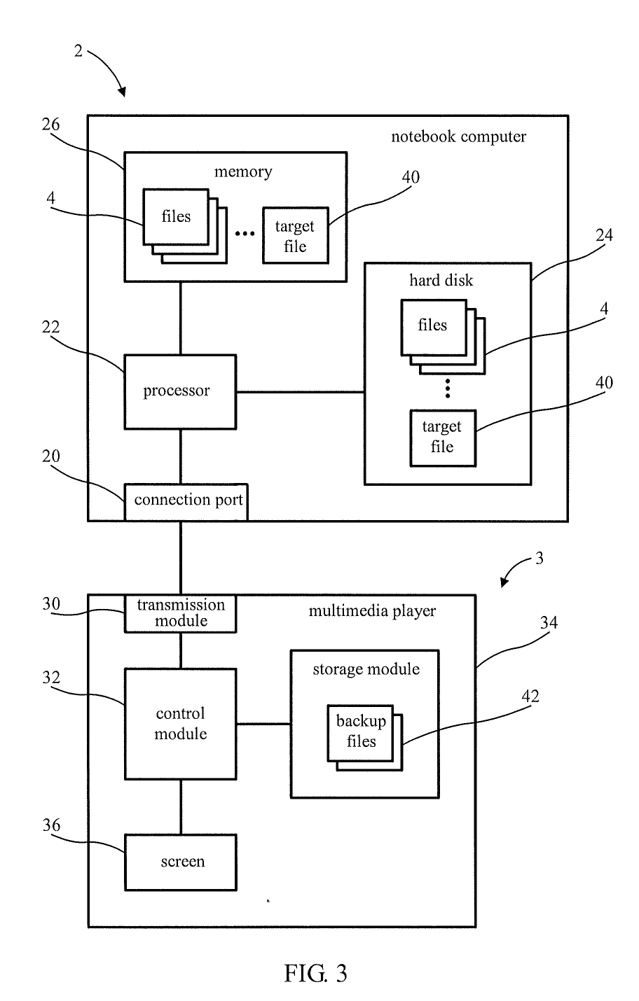

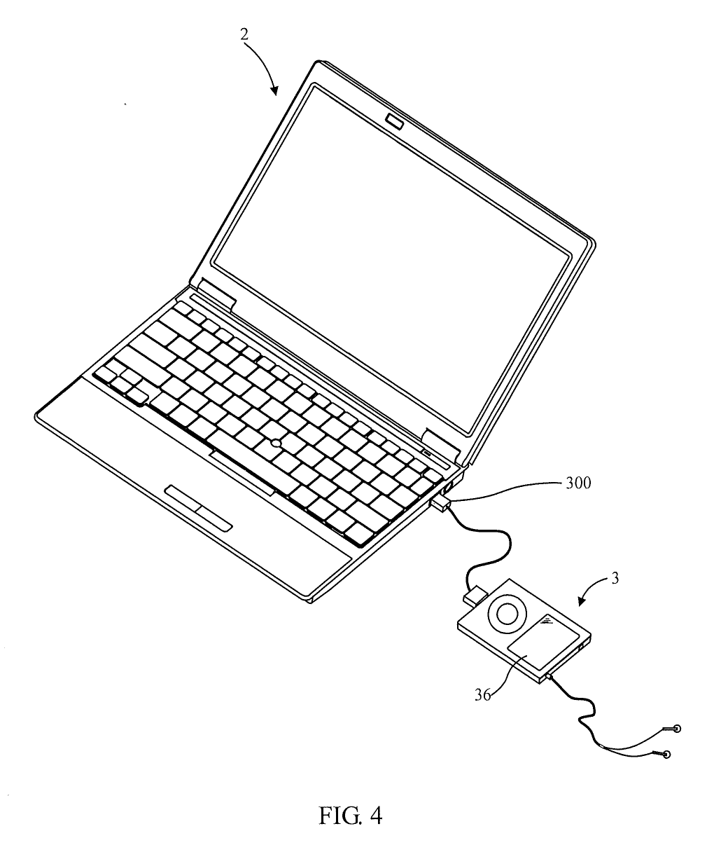

A multimedia player as the portable electronic device is taken for example in one embodiment of the invention hereinbelow. Please refer to FIG. 3 and FIG. 4 together. FIG. 3 is a functional block diagram showing a multimedia player 3 connected with a notebook computer 2. FIG. 4 is a schematic diagram showing the multimedia player 3 connected with the notebook computer 2. In the embodiment, units included in the notebook computer 2 and connections therebetween are the same as that described above. Therefore, they are not described herein for a concise purpose.

In FIG. 3, the multimedia player 3 includes a transmission module 30, a control module 32, and a storage module 34. As described above, the transmission module 30 is connected with the notebook computer 2. The control module 32 is connected with the transmission module 30 for automatically executing a backup program when the transmission module 30 is connected with the notebook computer 2, thus to copy target files 40 in the notebook computer 2 to be backup files 42 by the transmission module 30. The storage module 34 is connected with the control module 32 for receiving the backup files 42 from the control module 32 and storing the backup files 42.

The backup program may be similar to that described above. Therefore, they are not described herein for a concise purpose. Further, connections and functions of the transmission module 30, the control module 32, and the storage module 34 are also the same as that described above. For example, the transmission module 30 may include a wireless transmission element for connecting the notebook computer 2 in a wireless mode; the control module 32 may also include an AES module for encrypting the backup files 42. Therefore, they are not described herein for a concise purpose. According to the objectives of the invention, the actual applications of the peripheral device and the portable electronic device can make proper modifications and changes within the scope of the invention, and they are not limited to the embodiments described herein.

Particularly, different from the mouse described above, the multimedia player 3 in this embodiment further includes a screen 36 connected with the control module 32. The screen 36 can display the capacity of the storage module 34, the password request image described above, or other interfaces for communicating with the user. The user can also browse contents of the backup files 42 via the screen 36. Further, in an actual application, the multimedia player 3 may also include number buttons or even a mini keyboard. Thereby, the user may set a password, set the priority of files, or perform other related operation via the buttons or the keyboard.

To sum up, when the peripheral device or the portable electronic device in the embodiments of the invention is connected with the data processing system, it automatically back up the target files in the data processing system. The invention provides a convenient backup mode for backing up important data, thus to prevent the data from failing to be recovered after being damaged by external factors.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A peripheral device comprising:
a transmission module capable of being connected with a data processing system;
a control module connected with the transmission module, the control module automatically executing a backup program and an encryption program to copy a target file in the data processing system to generate a backup file by the transmission module and to encrypt the backup file when the transmission module being connected with the data processing system; and
a storage module connected with the control module for receiving the backup file from the control module and storing the backup file.

2. The peripheral device according to claim 1, wherein the transmission module comprises a universal serial bus hub.

3. The peripheral device according to claim 1, wherein the control module comprises an advanced encryption standard module including the encryption program.

4. The peripheral device according to claim 1, wherein the storage module stores backup software including the backup program, and when the transmission module is connected with the data processing system, the control module executes the backup program.

5. The peripheral device according to claim 1, wherein the storage module stores backup software including the backup program, and when the transmission module is connected with the data processing system, the control module transmits the backup software to the data processing system, and the data processing system executes the backup program.

6. The peripheral device according to claim 1, wherein the data processing system stores backup software including the backup program, and when the transmission module is connected with the data processing system, the control module transmits a driving signal via the transmission module to drive the data processing system to execute the backup program.

7. The peripheral device according to claim 1, wherein the backup program is recorded onto the control module in the mode of a program code, and when the transmission module is connected with the data processing system, the control module automatically executes the backup program.

8. The peripheral device according to claim 1, wherein the storage module is pluggably disposed in the peripheral device.

9. The peripheral device according to claim 1, wherein the transmission module comprises a wireless transmission element.

10. The peripheral device according to claim 1, further comprising a pointing module.

11. A portable electronic device comprising:
a transmission module capable of being connected with a data processing system;
a control module connected with the transmission module, the control module automatically executing a backup program to copy a target file in the data processing system to be a backup file by the transmission module when the transmission module being connected with the data processing system; and
a storage module connected with the control module for receiving the backup file from the control module and storing the backup file.

12. The portable electronic device according to claim 11, wherein the transmission module comprises a universal serial bus hub.

13. The portable electronic device according to claim 11, wherein the control module encrypts the backup file.

14. The portable electronic device according to claim 13, wherein the control module comprises an advanced encryption standard (AES) module including an encryption program for encrypting the backup file.

15. The portable electronic device according to claim 11, wherein the storage module stores backup software including the backup program, and when the transmission module is connected with the data processing system, the control module executes the backup program.

16. The portable electronic device according to claim 11, wherein the storage module stores backup software including the backup program, and when the transmission module is connected with the data processing system, the control module transmits the backup software to the data processing system, and the data processing system executes the backup program.

17. The portable electronic device according to claim 11, wherein the data processing system stores backup software including the backup program, and when the transmission module is connected with the data processing system, the control module transmits a driving signal via the transmission module to drive the data processing system to execute the backup program.

18. The portable electronic device according to claim 11, wherein the backup program is recorded onto the control module in the mode of a program mode, and when the transmission module is connected with the data processing system, the control module automatically executes the backup program.

19. The portable electronic device according to claim 11, wherein the storage module is pluggably disposed in the portable electronic device.

20. The portable electronic device according to claim 11, wherein the transmission module comprises a wireless transmission element.
